(19) United States
(12) Patent Application Publication
(10) Pub. No.: US 2007/0257238 A1
(43) Pub. Date: Nov. 8, 2007

(54) POLYMERIZABLE PHOTOCHROMIC COMPOSITIONS WITH MULTIPLE INITIATORS

(75) Inventors: Michael S. Misura, Clinton, OH (US); Kevin J. Stewart, Murrysville, PA (US)

Correspondence Address: Deborah M. Altman;PPG Industries, Inc., Law Department - Intellectual Property, One PPG Place - 39th Floor, Pittsburgh, PA, 15272-0001, US

(73) Assignee: TRANSITIONS OPTICAL, INC., Pinellas Park, FL (US)

(21) Appl. No.: 11/696,895

(22) Filed: Apr. 5, 2007

Related U.S. Application Data
(60) Provisional application No. 60/798,164, filed on May 5, 2006.

(51) Int. Cl. G02B 1/04

(52) U.S. Cl. 252/586

(57) ABSTRACT

Provided is a method of preparing a photochromic polymeric article including: (a) providing a fluid polymerizable composition of: at least one monomer; a first initiator for inducing polymerization of the monomer at a first temperature; and a second initiator for inducing further polymerization at a second temperature higher than the first temperature; (b) heating the polymerizable composition to at least the first temperature whereby the first initiator induces polymerization of the monomer at the first temperature to produce a polymerizate; (c) heating the polymerizate of (b) to at least the second temperature to further polymerize the polymerizate; and (d) contacting the polymerizate with an organic photochromic substance to incorporate the organic photochromic substance into the polymerizate. Photochromic articles prepared by the method are also provided.

This application claims the benefit of priority of U.S. Provisional Patent Application No. 60/798,164 filed May 5, 2006.

### BACKGROUND OF THE INVENTION

The present invention relates to photochromic compositions of monomers polymerizable with at least two initiators and to a method for improving the performance of organic photochromic compounds in polymeric substrates. More particularly, this invention relates to compositions comprising dual initiators and organic photochromic compound(s), and optionally, carrier, stabilizer and/or conventional additive(s). The dual initiators are used in amounts sufficient to improve the performance of organic photochromic compounds in polymeric organic host materials, e.g., polymerizates and polymeric coatings. Still more particularly, this invention relates to photochromic articles, e.g., ophthalmic lenses, made of polymeric substrates having incorporated therein organic photochromic compounds and initiators such as peroxy monocarbonates. The initiators are effective to polymerize the allyl functional monomers in two steps.

Photochromic compounds exhibit a reversible change in color when exposed to radiation including ultraviolet rays, such as the ultraviolet radiation in sunlight or the light of a mercury lamp. Various classes of photochromic compounds have been synthesized and suggested for use in applications in which a sunlight-induced reversible color change or darkening is desired. The most widely described classes are oxazines, chromenes and fulgides.

Photochromic compounds may be incorporated into plastic substrates, such as ophthalmic lenses, by various methods described in the art. Such methods include dissolving or dispersing the compound within the surface of a substrate, e.g., imbibition of the photochromic compound into the substrate by immersion of the substrate in a hot solution of the photochromic compound or by depositing the photochromic compound on the surface of the substrate and thermally transferring the photochromic compound into the substrate. The term “imbibition” or “imbibe” is intended to mean and include permeation of the photochromic compound into the substrate, solvent assisted transfer absorption of the photochromic compound into the substrate, vapor phase transfer and other such transfer mechanisms.

The extent to which the photochromic compounds penetrate the polymeric substrate generally increases with increasing temperature, increasing concentration of photochromic compounds at the surface of the polymeric substrate and increasing period of contact with the polymeric substrate. The ease with which the photochromic compounds are incorporated is also dependent upon the characteristics of the photochromic compounds and of the polymeric substrate. The molecular size, melting point and solvent solubility of the photochromic compounds as well as the receptivity of the polymeric substrate all affect the ease of incorporation of the photochromic compounds. Due to the numerous variables affecting production of photochromic articles, in some cases, photochromic compounds may not be incorporated into the plastic substrate with sufficient uniformity and to a sufficient depth. This can result in poor performance of the photochromic compound and inadequate reversible color change of the photochromic article.

Methods for incorporating photochromic compounds into polymeric substrates have been disclosed in U.S. Pat. Nos. 4,286,957; 4,880,667; 4,789,015; 5,914,193 and 5,975,696. Various photochromic compositions used in the process of incorporating photochromic compounds into polymeric substrates have been disclosed in U.S. Pat. Nos. 5,185,390; 5,391,327 and 5,770,115.

The aforementioned photochromic compositions and methods of incorporating photochromic compounds into polymeric substrates are generally known in the art and can be used in the process of the present invention.

The use of epoxy-containing compounds with photochromic compounds has been disclosed in U.S. Pat. Nos. 5,395,566; 5,462,698; 5,621,017 and 5,776,376. U.S. Pat. No. 5,395,566 discloses a photochromic composition of a compound having at least one radical polymerizable group and at least one epoxy group and a photochromic compound. U.S. Pat. No. 5,462,698 discloses a photochromic composition of a compound having at least one epoxy group, a fulgide compound and two different (meth)acrylic monomers. U.S. Pat. No. 5,621,017 discloses a photochromic composition of a radical polymerization monomer, photochromic compound and photopolymerization initiator. U.S. Pat. No. 5,776,376 discloses a photochromic composition of a polymerizable monomer composed of a compound having at least one epoxy group, various monomers, an α-methylstyrene dimmer and photochromic compounds.

In each of the aforedescribed patents disclosing compositions containing epoxy-containing compounds and photochromic compounds, the compositions contained radically polymerizable components and were polymerized to make photochromic lenses.

Another method for enhancing incorporation of photochromic compounds into polymeric substrates is described in U.S. Pat. No. 6,713,536. Kinetic enhancing additive(s) are included in a photochromic polymeric host material. Suitable kinetic enhancing additives include organic polyol(s), epoxy-containing compound(s) or a mixture thereof that improves the performance of organic photochromic compounds in the polymeric host.

Yet another method of preparing a photochromic article is disclosed in U.S. Pat. No. 6,811,830. A polymerizable composition is polymerized to an intermediate hardness and is contacted with a photochromic composition. The article of intermediate hardness containing the photochromic material is further cured to provide an article imbibed with the photochromic material.

Although methods exist for incorporating photochromic compounds into polymeric substrates, improvements in such methods are sought.

### SUMMARY OF THE INVENTION

The present invention includes a method of preparing a photochromic polymeric article comprising:
(a) providing a fluid polymerizable composition comprising a mixture of:
   at least one monomer;
   a first initiator for inducing polymerization of the monomer at a first temperature; and
   a second initiator for inducing further polymerization at a second temperature higher than the first temperature;
(b) heating the polymerizable composition to at least the first temperature whereby the first initiator induces polymerization of the monomer at the first temperature to produce a polymerizate;
(c) heating the polymerizate of (b) to at least the second temperature to further polymerize the polymerizate; and
(d) contacting the polymerizate with an organic photochromic substance to incorporate the organic photochromic substance into the polymerizate.

The present invention also provides a method of preparing a photochromic polymeric article comprising:
(a) providing a fluid polymerizable composition;
(b) heating the polymerizable composition to induce polymerization and produce a polymerizate; and
(c) contacting the polymerizate with an organic photochromic substance to incorporate the organic photochromic substance into the polymerizate.

The present invention is also directed to a method of preparing a photochromic polymeric article comprising:
(a) providing a fluid polymerizable composition comprising a monomer;
(b) curing the polymerizable composition to produce a polymerizate having a double bond conversion of 80 to 90% of the double bonds in the fluid polymerizable composition;
(c) contacting a surface of the polymerizate with a stabilizer composition;
(d) contacting said surface of the polymerizate with a photochromic composition; and
(e) curing said surface of the polymerizate.

Photochromic articles prepared by the above-described methods are also provided.

### DETAILED DESCRIPTION OF THE INVENTION

The process of the present invention includes a method of preparing a photochromic polymeric article. The process generally includes casting of a fluid polymerizable composition using a suitable mold. The photochromic article is typically a shaped article, such as a sheet, film or lens. A fluid polymerizable composition is heated to induce polymerization and produce a polymerizate. The fluid polymerizable composition includes at least one monomer, a first initiator for polymerizing the monomer at a first temperature and a second initiator for polymerizing the monomer at a second temperature higher than the first temperature. By “initiator” it is meant a material capable of generating free radicals, such as organic peroxy compounds.

Several classes of organic peroxy compounds may be used in the present invention. The following classes of compounds are listed in approximate increasing order of temperatures at which the representative compounds are effective as initiators: diacylperoxides, such as 2,4-dichlorobenzoyl peroxide, isobutyryl peroxide, decanoyl peroxide, lauroyl peroxide, propionyl peroxide, acetyl peroxide, benzoyl peroxide, p-chlorobenzoyl peroxide; peroxyesters such as t-butylperoxy pivalate, t-butylperoxy octylate, and t-butylperoxyisobutyrate; methylethylketone peroxide, acetylcyclohexane sulfonyl peroxide, and azobisisobutyronitrile; peroxydicarbonate esters, such as di(2-ethylhexyl)peroxydicarbonate, di(secondary butyl)peroxydicarbonate and diisopropylperoxydicarbonate; peroxymonocarbonate esters, such as t-butyl peroxy 2-ethylhexyl carbonate and t-butylperoxy isopropyl carbonate; peroxyketals such as di(t-butylperoxy)cychlohexane dialkyl peroxides such as dimethyl-di(t-butylperoxy)hexane; and hydroperoxides such as t-butyl hydroperoxide.

Suitable initiators can include those that do not discolor the resulting polymerizate.

In one embodiment, the first initiator can comprise those having a one hour t ½ value of less than 70° C. Such initiators can include diisopropyl peroxydicarbonate (IPP), diisopropyl peroxydicarbonate, di(n-propyl peroxydicarbonate, di(sec-butyl)peroxydicarbonate, di(2-ethylhexyl)peroxydicarbonate, 1,1-dimethyl-3-hydoxybutylperoxyneodecanoate, a-cumylperoxynecodecanoate, t-amylperoxyneodecanoate and/or t-butylperoxyneodecanoate.

The second initiator can include those having a one hour t ½ value between 100° C. and 125° C. Suitable second initiators include t-butyl peroxy 2-ethylhexyl carbonate (TBEC), and OO-t-butyl O-isopropyl monoperoxycarbonate, OO-t-amyl-O-(2-ethylhexyl)monoperoxycarbonate, t-butylperbenzoate, and/or t-amylperbenzoate.

Other initiators may be used in the present invention.

Heating of the polymerizable composition to induce polymerization and produce a polymerizate results in a polymerizate which is substantially cured. The curing may be conducted by thermal curing, as well as radiation curing or a combination thereof. By “substantially cured” it is meant that the change in percentage conversion of double bonds in the fluid polymerizable composition between the polymerizate and the polymerizable composition is in the range of 75 to 90%, such as 80 to 90%, e.g., 82 to 90%.

The fluid polymerizable composition typically includes at least two thermal polymerization initiators, including a relatively low temperature initiator and a relatively high temperature initiator. That is the first initiator activates polymerization of the polymerizable composition at a first temperature; and the second initiator activates polymerization at a second temperature which is higher than the first temperature. The first heating step is carried out at a temperature sufficient to activate the low temperature initiator to yield a polymerizate. At the completion of the first heating step, the polymerizate is heated in a second heating step to at least the second temperature to further polymerize the polymerizate. The polymerizate is then contacted with an organic photochromic substance to incorporate the organic photochromic substance into the polymerizate as described herein below.

During the second heating step, a stabilizer composition may be incorporated into the polymerizate. In one embodiment, the stabilizer composition comprises a hindered amine light (HAL) stabilizer. The stabilizer typically acts by scavenging free radicals that can be formed in a photo-oxidation process. Hindered amine light stabilizers are efficient stabilizers against light-induced degradation of polymers. They do not absorb UV radiation, but act to inhibit degradation of the polymer, thus extending its durability. Hindered light amines are regenerated and not consumed during the stabilization process. Suitable stabilizers can include Irganox 259 available from Ciba Specialty Chemicals, Sandoz 3055 and Sanduvor PR-31 both available from Clariant.

The stabilizer composition is incorporated into the polymerizate by bringing it in contact with a surface of the polymerizate and, typically simultaneously, subjecting it to heat to cause thermal transfer to the polymerizate. Heating typically occurs at a temperature ranging from 120° C. to 140° C., such as from 125° C. to 135° C.

As previously mentioned, any of the polymerizates described below can then be contacted with an organic photochromic substance to incorporate the photochromic substance into the polymerizate. Subsequent to contacting the polymerizate with the photochromic substance, the polymerizate may be further heated.

Suitable polymerizates can include any of those known in the art. Such polymerizates can include polymers, i.e., homopolymers and copolymers, of polymerizable allylic monomers such as polyol(allyl carbonate) monomers, e.g., diethylene glycol bis(allyl carbonate) monomers such as those which are sold under the trademark CR-39, CR 607 and CR-630 all available from PPG Industries, Inc. of Pittsburgh, Pa.; diallylidene penaerythritol monomers; with other copolymerizable monomeric materials, such as copolymers with vinyl acetate, e.g., copolymers of from 80-90 percent diethylene glycol bis(allyl carbonate) and 10-20 percent vinyl acetate; particularly 80-85 percent of the bis(allyl carbonate) and 15-020 percent vinyl acetate, and copolymers with a polyurethane having terminal diacrylate functionality, as described in U.S. Pat. Nos. 4,360,653 and 4,994,208; and copolymers with aliphatic urethanes, the terminal portion of which contain allyl functional groups, as described in U.S. Pat. No. 5,200,483. In one embodiment, the polymerizate comprises a polymerizable composition comprising up to and including 10 weight percent of allylic monomers.

The amount of the first initiator used in the polymerizable composition may range from 1.2 to 2.5 weight percent, such as 1.5 to 2.0 weight percent of the polymerizable composition. The amount of the second initiator can range from 0.01 to 0.2 weight percent, such as from 0.05 to 0.15 weight percent of the polymerizable composition.

The photochromic materials described herein, e.g., the photochromic composition of the present invention and other photochromic materials, can be chosen from any of a variety of photochromic materials known in the art. Non-limiting examples include: a single photochromic compound; a mixture of photochromic compounds; a material comprising at least one photochromic compound, such as a plastic polymeric resin or an organic monomeric or oligomeric solution; a material such as a monomer or polymer to which at least one photochromic compound is chemically bonded; a material comprising and/or having chemically bonded to it at least one photochromic compound, the outer surface of the material being encapsulated (encapsulation is a form of coating), for example with a polymeric resin or a protective coating such as a metal oxide that prevents contact of the photochromic material with external materials such as oxygen, moisture and/or chemicals that have a negative effect on the photochromic material, such materials can be formed into a particulate prior to applying the protective coating as described in U.S. Pat. Nos. 4,166,043 and 4,367,170; a photochromic polymer, e.g., a photochromic polymer comprising polymerized photochromic monomers; or mixtures thereof. Additionally, suitable photochromic materials can include those comprising the reaction product of a ring-opening cyclic monomer and a photochromic initiator such as those described in U.S. Patent Application Publication No. 2006/0022176 A1 at [0029] to [0088], the cited portions of which are incorporated herein by reference. Further, suitable photochromic materials can include the photosensitive microparticles described in U.S. Patent Application Publication No. 2006/0014099 A1 at [0007] to [0095] and [0107] to [0133], the cited portions of which are incorporated herein by reference.

In another non-limiting embodiment, the other photochromic materials can include the following classes of materials: chromenes, e.g., naphthopyrans, benzopyrans, indenonaphthopyrans, phenanthropyrans or mixtures thereof; spiropyrans, e.g., spiro(benzindoline)naphthopyrans, spiro(indoline)benzopyrans, spiro(indoline)naphthopyrans, spiro(indoline)quinopyrans and spiro(indoline)pyrans; oxazines, e.g., spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates, fulgides, fulgimides and mixtures of such photochromic materials.

Such photochromic materials and complementary photochromic materials are described in U.S. Pat. No. 4,931,220 at column 8, line 52 to column 22, line 40; U.S. Pat. No. 5,645,767 at column 1, line 10 to column 12, line 57; U.S. Pat. No. 5,658,501 at column 1, line 64 to column 13, line 17; U.S. Pat. No. 6,022,495 at column 2, line 30 to column 23, line 50; U.S. Pat. No. 6,022,497 at column 2, line 22 to column 18, line 61; U.S. Pat. No. 6,080,338 at column 2, line 21 to column 14, line 43; U.S. Pat. No. 6,136,968 at column 2, line 43 to column 20, line 67; U.S. Pat. No. 6,153,126 at column 2, line 18 to column 8, line 60; U.S. Pat. No. 6,296,785 at column 2, line 47 to column 31, line 5; U.S. Pat. No. 6,348,604 at column 3, line 26 to column 17, line 15; U.S. Pat. No. 6,353,102 at column 1, line 62 to column 11, line 64; and U.S. Pat. No. 6,630,597 at column 2, line 16 to column 16, line 23; the disclosures of the aforementioned patents are incorporated herein by reference. Spiro(indoline)pyrans are also described in the text, Techniques in Chemistry, Volume III, “Photochromism”, Chapter 3, Glenn H. Brown, Editor, John Wiley and Sons, Inc., New York, 1971.

In a further non-limiting embodiment, the other photochromic materials can be polymerizable photochromic materials, such as polymerizable naphthoxazines disclosed in U.S. Pat. No. 5,166,345 at column 3, line 36 to column 14, line 3; polymerizable spirobenzopyrans disclosed in U.S. Pat. No. 5,236,958 at column 1, line 45 to column 6, line 65; polymerizable spirobenzopyrans and spirobenzothiopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated naphthopyrans disclosed in U.S. Pat. No. 6,113,814 at column 2, line 23 to column 23, line 29; and the polymerizable photochromic materials disclosed in U.S. Pat. No. 6,555,028 at column 2, line 40 to column 31, line 64. The disclosures of the aforementioned patents on polymerizable photochromic materials are incorporated herein by reference.

Other non-limiting embodiments of photochromic materials that can be used include organo-metal dithiozonates, e.g., (arylazo)-thioformic arylhydrazidates, e.g., mercury dithizonates which are described in, for example, U.S. Pat. No. 3,361,706 at column 2, line 27 to column 8, line 43; and fulgides and fulgimides, e.g., the 3-furyl and 3-thienyl fulgides and fulgimides, which are described in U.S. Pat. No. 4,931,220 at column 1, line 39 through column 22, line 41, the disclosures of which are incorporated herein by reference.

An additional non-limiting embodiment of the other photochromic materials is a form of organic photochromic material substantially resistant to the effects of a polymerization initiator that can also be used in the photochromic articles of the present invention. Such organic photochromic materials include photochromic compounds in admixture with a resinous material that has been formed into particles and encapsulated in metal oxides, which are described in U.S. Pat. Nos. 4,166,043 and 4,367,170 at column 1, line 36 to column 7, line 12, which disclosures are incorporated herein by reference.

The photochromic compounds used in the photochromic composition of the present invention may be used alone or in combination with one or more other appropriate complementary organic photochromic compounds, i.e., organic photochromic compounds having at least one activated absorption maxima within the range of 400 and 700 nanometers, and which color when activated to an appropriate hue.

The photochromic articles of the present invention may contain one photochromic compound or a mixture of photochromic compounds, as desired.

Each of the photochromic substances described herein may be used in amounts (or in a ratio) such that a polymeric substrate to which the photochromic composition is associated, exhibits a desired resultant color, e.g., a substantially neutral color when activated with unfiltered sunlight, i.e., as near a neutral color as possible given the colors of the activated photochromic compounds. Neutral gray and neutral brown colors are preferred. Further discussion of neutral colors and ways to describe colors may be found in U.S. Pat. No. 5,645,767 at column 12, line 66 to column 13, line 19.

The amount of the photochromic compounds to be used in the imbibition composition, which is incorporated into a polymeric organic host material, is not critical provided that a sufficient amount is used to produce a photochromic effect discernible to the naked eye upon activation. Generally, such amount can be described as a photochromic amount. In the process of the present invention, this amount may be transferred onto the polymeric host all at once or by first transferring a portion of the amount in one step followed by the remainder in one or more subsequent transfers. The particular amount used depends often upon the intensity of color desired upon irradiation thereof and upon the method used to incorporate the photochromic composition. Typically, the more photochromic compound incorporated, the greater is the color intensity up to a certain limit.

The relative amounts of the aforesaid photochromic compounds used will vary and depend in part upon the relative intensities of the color of the activated species of such compounds, the ultimate color desired and the method of application of the photochromic composition to the polymeric substrate. In a typical commercial imbibition process, the amount of total photochromic compound incorporated into a receptive polymeric substrate may range from 0.05 to 2.0, e.g., from 0.2 to 1.0 milligrams per square centimeter of surface to which the photochromic compound is incorporated or applied.

The amount of photochromic substance or composition containing same applied to or incorporated into the polymerizate is not critical provided that a sufficient amount is used to produce a photochromic effect discernible to the naked eye upon activation. Generally, such amount can be described as a photochromic amount. The particular amount used depends often upon the intensity of color desired upon irradiation thereof and upon the method used to incorporate or apply the photochromic substances. Typically, the more photochromic substance applied or incorporated, the greater is the color intensity. Generally, the amount of total photochromic substance incorporated into or applied to a photochromic optical polymerizate may range from 0.15 to 0.35 milligrams per square centimeter of surface to which the photochromic substance(s) is incorporated or applied.

Photochromic articles prepared by the method of present invention may be coated with a silica, titania, and/or zirconia-based hard coating material. Alternatively, an organic hard coating material of the ultraviolet curable type may be applied so as to form a hard surface layer. Application of such protective coatings, e.g., abrasion resistant coatings, may be by any of the methods used in coating technology such as, for example, spray coating, spin coating, spread coating, curtain coating, dip coating or roll-coating. Other coatings and/or surface treatments, e.g., antireflective surface, hydrophobic coating, etc., may also be applied individually or sequentially to at least one surface of the photochromic articles of the present invention. An antireflective coating, e.g., a monolayer or multilayer of metal oxides, metal fluorides, or other materials, may be deposited onto the photochromic articles, e.g., lenses of the present invention through vacuum evaporation, sputtering, or some other method.

The present invention is also directed to a method of preparing a photochromic polymeric article comprising:

(a) providing a fluid polymerizable composition such as any of those described above; (b) heating the polymerizable composition to induce polymerization and produce a polymerizate; and (c) contacting the polymerizate with an organic photochromic substance such as those describe above to incorporate the organic photochromic substance into the polymerizate. The heating temperature can range for example, from 50 to 150 provided the temperature is sufficient to substantially cure the polymerizable composition.

The present invention is also directed to a method of preparing a photochromic polymeric article comprising: (a) providing a fluid polymerizable composition comprising a monomer; (b) curing the polymerizable composition to produce a polymerizate having a double bond conversion of 80 to 90% of the double bond in the fluid polymerizable composition; (c) contacting a surface of the polymerizate with a stabilizer composition; contacting said surface of the polymerizate with a photochromic composition; and curing said surface of the polymerizate.

The polymerizate prepared by any of the aforementioned methods can have a Barcol hardness of from 50 to 70, such as from 55 to 65.

The present invention has been described with reference to specific details of particular embodiments thereof. It is not intended that such details be regarded as limitations upon the scope of the invention except insofar as to the extent that they are included in the accompanying claims.

The invention claimed is:

1. A method of preparing a photochromic polymeric article comprising:
(a) providing a fluid polymerizable composition comprising a mixture of:
at least one monomer;
a first initiator for inducing polymerization of the monomer at a first temperature; and
a second initiator for inducing further polymerization at a second temperature higher than the first temperature;
(b) heating the polymerizable composition to at least the first temperature whereby the first initiator induces polymerization of the monomer at the first temperature to produce a polymerizate;
(c) heating the polymerizate of (b) to at least the second temperature to further polymerize the polymerizate; and
(d) contacting the polymerizate with an organic photochromic substance to incorporate the organic photochromic substance into the polymerizate.

2. The method of claim 1 wherein the polymerizate produced in step (b) has a Barcol hardness of 50 to 70.

3. The method of claim 1 wherein the polymerizate procedure in step (b) has a double bond conversion of 75 to 90% of the double bonds in the fluid polymerizable composition.

4. The method of claim 1 wherein in (c), the polymerizate is contacted with a stabilizer composition.

5. The method of claim 4 wherein the stabilizer composition comprises a hindered amine light stabilizer.

6. The method of claim 1 wherein the first initiator comprises diisopropyl peroxydicarbonate, di(n-propylperoxydicarbonate, di(sec-butyl)peroxydicarbonate, di(2-ethylhexyl)peroxydicarbonate, 1,1-dimethyl-3-hydoxybutylperoxyneodecanoate, a-cumylperoxynecodecanoate, t-amylperoxyneodecanoate and/or t-butylperoxyneodecanoate.

7. The method of claim 1 wherein the second initiator is selected from the group consisting of t-butylperoxy 2-ethylhexyl carbonate, OO-t-butyl O-isopropyl monoperoxycarbonate, OO-t-amyl-O-(2-ethylhexyl)monoperoxycarbonate, t-butylperbenzoate, and/or t-amylperbenzoate.

8. A method of preparing a photochromic polymeric article comprising:
(a) providing a fluid polymerizable composition comprising a monomer;
curing the polymerizable composition to produce a polymerizate having a double bond conversion of 80 to 90% of the double bond in the fluid polymerizable composition;
(b) contacting a surface of the polymerizate with a stabilizer composition;
(c) contacting said surface of the polymerizate with a photochromic composition; and
(d) curing said surface of the polymerizate.

9. The method of claim 8 wherein the polymerizable composition comprises a first initiator for polymerizing the monomer at a first temperature, and a second initiator for polymerizing the monomer at a second temperature higher than the first temperature, said curing step (b) comprising heating the polymerizable composition to at least the first temperature to polymerize the monomer.

10. A photochromic article produced according to the method of claim 1.

11. A photochromic article produced according to the method of claim 8.
